(19) United States
(12) Patent Application Publication
(10) Pub. No.: US 2007/0141434 A1
(43) Pub. Date: Jun. 21, 2007

(54) Sanitizing Device and Associated Method Using Electrochemically Produced Sanitizing Agents

(76) Inventors: Ashok V. Joshi, Salt Lake City, UT (US); Shekar Balagopal, Sandy, UT (US); Justin Pendelton, Salt Lake City, UT (US)

Correspondence Address: CERAMATEC, INC., 2425 SOUTH 900 WEST, SALT LAKE CITY, UT, 84119, US

(21) Appl. No.: 11/671,419

(22) Filed: Feb. 5, 2007

Related U.S. Application Data
(63) Continuation-in-part of application No. 09/603,179, filed on Jun. 26, 2000, now Pat. No. 7,172,734.

(51) Int. Cl. H01M 2/02

(52) U.S. Cl. 429/34

(57) ABSTRACT

A sanitizing device includes a sanitizing component for sanitizing a surface, liquid, gas, and/or associated surrounding environment. The sanitizing component may be an electrochemical cell having an anode, a cathode, and an electrolyte component, that works in cooperation with a power source and a precursor material. The electrochemical cell, power source and precursor material may be supported by a housing. Upon application of potential across the electrodes of the electrochemical cell, a sanitizer is formed from the precursor material. The housing contains an outlet for releasing the sanitizer.

### RELATED APPLICATIONS

This application claims the benefit of, and is a continuation-in-part of, U.S. patent application Ser. No. 09/603,179 filed Jun. 26, 2000 and entitled Sanitizing Device and Associated Method, which is hereby incorporated by reference.

### BACKGROUND OF THE INVENTION

1. Field of the Invention

The present invention relates in general to a sanitizing device having an electrochemical cell, and more particularly, to a sanitizing device having an electrochemical as a component to sanitize, disinfect, and/or otherwise beneficially affect surfaces, liquids, gasses, and/or associated surrounding environments.

2. Background Art

Sanitizing devices have been known in the art for several years and are the subject of many United States Patents including: U.S. Pat. Nos. 5,874,050; 5,441,710; 3,691,346; 3,654,432; and 5,928,481.

U.S. Pat. No. 5,874,050 discloses a room air sterilization device having an elongated member with a plurality of narrow, substantially parallel passages extending from a first end to a second end. Heating wire, fabricated from a nickel chromium resistive material, is positioned within the passages. Upon application of a power source, including AC/DC current, the heating wire radiates heat within the passages, thereby raising the air to a sufficient temperature to become sterilized and rise from the passage via convection current.

U.S. Pat. No. 5,441,710 discloses an air flow sterilizer for destroying microorganisms by heating an air flow to a sufficient temperature to weaken cellular walls of the microorganisms. Turbulence is introduced into the air flow so that the weakened microorganisms are destroyed upon hitting a surface of the turbulent chamber.

U.S. Pat. No. 3,654,432 discloses an electrically heated catalytic air purifier having a heating unit for treating air borne particles. The heating unit includes a surface coating of silicon carbide which functions at an operating temperature between 250 and 350 degrees centigrade.

U.S. Pat. No. 5,928,481 discloses an apparatus for sterilizing water by the process of heavy metal sterilization using silver.

### SUMMARY OF THE INVENTION

The present invention is directed to a sanitizing device comprising: (a) a sanitizing component for sanitizing a surface, liquid, gas, and/or associated surrounding environment, wherein the sanitizing component includes an electrochemical cell, a chemical component, and/or corona cell; and (b) a housing for retaining the sanitizing component.

In one embodiment of the invention, the sanitizing component comprises a porous matrix substantially impregnated with a material selected from the group consisting essentially of peroxides, superoxides, fluorates, chlorates, bromates, iodates, permanganates, and mixtures thereof. In this embodiment the porous matrix may comprise one or more materials selected from the group consisting essentially of plastics, carbonaceous materials, ceramics, metals, and mixtures thereof.

In another embodiment of the invention the sanitizing device further comprises power source for powering an electrochemical and/or corona cell, wherein the power source consists of AC current and/or DC current. In this embodiment the sanitizing component comprises the electrochemical and/or corona cell.

If a corona cell is associated with the sanitizing device of the present invention, the corona cell may comprise a dielectric material and two electrodes.

If an electrochemical cell is associated with the sanitizing device of the present invention, such an electrochemical cell may include an anode, a cathode, and an electrolyte component. The electrolyte component may comprise a solid phase material, and may also serve as a partial or full component of the device, such as, for example, a housing, porous matrix, or particulate filtering component.

In one embodiment both the anode and the cathode component comprise the same or different materials selected from the group consisting essentially of metals such as, titanium, nickel, steel, copper, silver, platinum, palladium, zinc, aluminum, and mixtures and alloys thereof, and conductive ceramics such as, perovskites, carbides and nitrides of metals. The anode and cathode may also comprise carbon.

In yet another embodiment of the invention, the electrolyte component comprises a material selected from the group consisting essentially of a halide containing material, an oxide containing material, an ion exchange membrane, an alkali ion conducting material, a silver or copper ion conducting material, and an ion conducting ceramic material and mixtures, compounds, and alloys thereof. In this embodiment the halide containing material may include halides of metals, their mixtures and compounds as well as their composites with plastic and ceramic materials. Oxide containing materials may include composites of metal oxides and ion conducting materials (e.g. AgI-Al₂O₃ composites) as well as beta-aluminas's (MₓO-11Al₂0₃) or Nasicon materials.

In accordance with the present invention, an ion exchange membrane may comprise Nafion, Nasicon, and/or beta-alumina materials in which any monovalent or divalent ion can be substituted such as, for example, Ag, Cu, Li, Rb, Na, H, Mg, Etc.

In accordance with the present invention, silver and copper ion conducting materials may include inorganic and/or organic compounds of silver and/or copper (e.g. halides, chalcogenides, phosphates, tungstates, zirconates, aluminates, and titanates of silver and/or copper), which have ionic conductivity greater than approximately 10⁻¹⁰ (ohm cm)⁻¹ at ambient temperatures.

In one embodiment, the device sanitizes or purifies by generating a sanitizing material. As used throughout this specification and claims, the term “sanitizing material” is used synonymously with “sanitizing agent” and “sanitizer.” The sanitizing device contains a precursor material from which the sanitizer is generated or synthesized.

In accordance with the present invention alkali ion conducting materials may include lithium, sodium, rubidium, cesium ion conducting materials with ionic conductivity greater than approximately 10⁻¹⁰ (ohm cm)⁻¹ at ambient temperatures.

In yet another embodiment of the present invention, the dielectric material of an associated corona cell may comprise a material selected from the group consisting of an oxide containing ceramic material and/or plastic material having a dielectric constant less than 100 and an electronic conductivity less than 10⁻⁷ (ohm cm)⁻¹.

In accordance with the present invention, an electrode associated with a corona cell may comprise materials selected from the group consisting essentially of metals such as, for example, titanium, nickel, steel, copper, silver, platinum, tungsten, palladium, aluminum, and mixtures and alloys thereof, as well as conductive ceramics such as, perovskites, carbides and nitrides of metals and mixtures thereof.

In one embodiment of the invention, a particulate filtering component may also be associated with the housing which is capable of substantially trapping particulates thereon, such as an activated carbonaceous filter component.

The sanitizing device of the present invention may also be associated with forced air means including a fan, a blower, etc.

The present invention is also directed to a multi-layer composite sanitizing device comprising: (a) a sanitizing component associated with a housing for sanitizing a surface, liquid, gas, and/or associated surrounding environment, wherein the sanitizing component includes an electrochemical, chemical, and/or corona cell; (b) a particulate filtering component capable of substantially trapping particulates thereon; and (c) a housing for retaining the sanitizing component and the particulate filtering component.

The present invention is further directed to a process for sanitizing a surface comprising the steps of: (a) providing a sanitizing component such as an electrochemical, chemical, and/or corona cell retained within a housing; (b) contacting the sanitizing component of the device with a surface; and (c) substantially sanitizing the surface.

The present invention is further directed to a process for sanitizing a liquid, gas and/or other matter, comprising the steps of: (a) providing a sanitizing component such as an electrochemical, chemical, and/or corona cell retained within a housing; (b) passing liquid, gas, and/or other matter over the sanitizing component; (c) contacting the sanitizing component with the liquid, gas, and/or other matter; and (d) substantially sanitizing the liquid, gas, and/or other matter.

### BRIEF DESCRIPTION OF THE DRAWINGS

The invention will now be described with reference to the drawings wherein:

FIG. 1 of the drawings is a schematic representation of a sanitizing device in accordance with the present invention;

FIG. 2 of the drawings is a fragmented side view of a sanitizing device in accordance with the present invention showing an electrochemical sanitizing component;

FIG. 3 of the drawings is a side view of a sanitizing device accordance with the present invention showing an electrochemical sanitizing component associated with a particulate filtering component;

FIG. 4 of the drawings is a side view of a sanitizing device in accordance with the present invention showing an electrochemical sanitizing component associated with both a particulate filtering component as well as with fragrance emitting means;

FIG. 5 of the drawings is a side view of a sanitizing device in accordance with the present invention associated with forced air means;

FIG. 6 of the drawings is a schematic representation of a sanitizing device in accordance with the present invention configured as a water purifier;

FIG. 7 of the drawings is a schematic representation of a sanitizing device in accordance with the present invention configured as a surface disinfectant device;

FIG. 8 of the drawings is a schematic representation of a sanitizing device in accordance with the present invention configured as a surrounding area sanitizing device;

FIG. 9 of the drawings is a cross-sectional view of one embodiment of a physical implementation of a sanitizing device in accordance with the invention; and

FIG. 10 is a cross-sectional view of one embodiment of a physical implementation of a sanitizing device in accordance with the invention.

### DETAILED DESCRIPTION OF THE INVENTION

It will be readily understood that the components or elements of the embodiments as generally described and illustrated in the Figures herein could be arranged and designed in a wide variety of different configurations. Thus, the following more detailed description of various embodiments, as represented in the Figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, characteristics, and uses of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

In the following description, numerous specific details are provided, such as examples of housings, barriers, chambers etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations such as vacuum sources are not shown or described in detail to avoid obscuring aspects of the invention.

In addition, although the term “sanitize” will be used in various forms throughout the disclosure, it should be understood that the device is also capable of “purifying” and producing a purifier as well.

Referring now to the drawings and to FIG. 1 in particular, sanitizing device 10 is shown in a first embodiment as generally comprising housing 12 and sanitizing component 14 for sanitizing contaminants, such as microorganisms, germs, bacteria, viruses, undesirable chemicals and/or compounds, etc. Housing 12 may be fabricated from any one of a number of materials including natural and synthetic resins, plastics, metals, woods, etc. While sanitizing device 10 has been shown as being substantially rectangular, numerous other geometric configurations are likewise contemplated for use including generally circular, generally elliptical, generally square, generally triangular, generally polygonal, and generally arbitrary—just to name a few.

For purposes of the present invention, sanitizing component 14 includes an electrochemical, chemical, and/or corona cell or purifier. The chemical purifier may comprise a porous matrix substantially impregnated with one or more of the following materials, namely: peroxides; superoxides; fluorates; chlorates; bromates; iodates; and permanganates. While it is desirous for the above-identified materials to be relatively pure, the presence of nominal amounts of other materials does not appear to be detrimental to the present invention—so long as the concentration of the sanitizing material remains high enough to perform its intended function of killing a substantial majority of the above-identified contaminants. The porous matrix of sanitizing component 14 is fabricated from carbonaceous materials, plastics, ceramics, metals, and mixtures thereof.

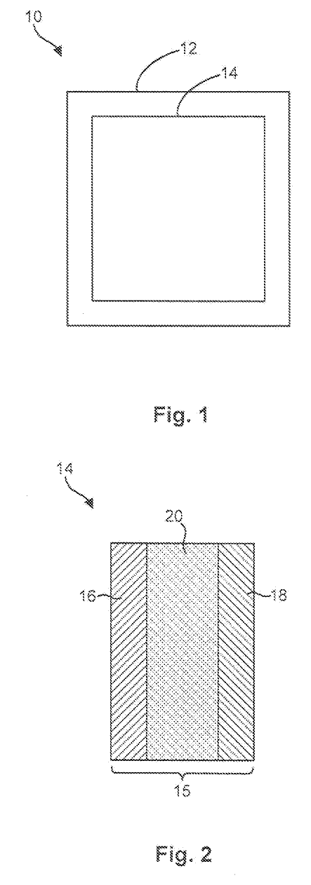

When an electrochemical and/or corona cell or purifier is incorporated into sanitizing device 10, it may be operated by AC current and/or DC current. However, numerous other power sources that would be known to those having ordinary skill in the art are likewise contemplated for use. As is shown in FIG. 2, sanitizing component 14 may include an electrochemical cell 15 comprising anode 16, cathode 18, and electrolyte component 20.

Anode 16 and cathode 18 may be fabricated from the same or different materials, including metals, conductive ceramics (including a particulate filtering component), and mixtures thereof. In one embodiment, metals include transitions metals such as titanium, nickel, copper, silver, platinum, palladium, zinc, as well as aluminum, steel, and mixtures and alloys thereof, and conductive ceramics may include perovskites, carbides, nitrides of metals, and mixtures thereof.

While some anode and cathode materials have been disclosed, for illustrative purposes only, it will be understood that numerous other conventional anode and cathode materials are likewise contemplated for use.

Electrolyte component 20 may be fabricated from several materials including, for example, a halide containing material, an oxide containing material, an ion exchange membrane, an alkali ion conducting material, a silver or copper ion conducting material, and an ion conducting ceramic material and mixtures, compounds, and alloys thereof.

In one embodiment, halide containing materials include halides of metals, their mixtures and compounds as well as their composites with plastic and ceramic materials. For example, the halide containing material may include one or more of the following materials, PbI₂, PbF₂, LaF₃, AgRbI₅, AgI-Al₂O₃, CuI-Al₂O₃, and mixtures thereof

In accordance with the present invention, oxide containing materials may include composites of metal oxides and ion conducting materials (e.g. AgI-Al₂O₃composites) as well as beta-aluminas's (MₓO-11Al₂O₃) or Nasicon materials.

In one embodiment, an ion exchange membrane comprises Nafion® manufactured by the DuPont Company, Nasicon, and/or beta-alumina materials in which any monovalent or divalent ion can be substituted such as, for example, Ag, Cu, Li, Rb, Na, H, Mg, Etc.

Suitable silver and copper ion conducting materials may include inorganic and/or organic compounds of silver and/or copper (e.g. halides, chalcogenides, phosphates, tungstates, zirconates, aluminates, and titanates of silver and/or copper), which have ionic conductivity greater than approximately 10⁻¹⁰ (ohm cm)⁻¹ at ambient temperatures.

In accordance with the present invention, alkali ion conducting materials may include lithium, sodium, rubidium, cesium ion conducting materials with ionic conductivity greater than approximately 10⁻¹⁰ (ohm cm)⁻¹ at ambient temperatures.

While several specific electrolyte components have been disclosed, for illustrative purposes only, it will be understood that other electrolyte components are suitable for use in accordance with the present invention—so long as the particular material(s) substantially sanitize associated contaminants contained therein.

If a corona cell is associated with the present invention, such cell may comprise electrode materials selected from the group consisting essentially of metals such as, for example, titanium, nickel, steel, copper, silver, platinum, tungsten, palladium, aluminum, and mixtures and alloys thereof, as well as conductive ceramics such as, perovskites, carbides and nitrides of metals and mixtures thereof. Further, if a corona cell is associated with the present invention, then such a cell may comprise dielectric materials selected from the group consisting of metal oxides such as titanium, aluminum and silicon oxides.

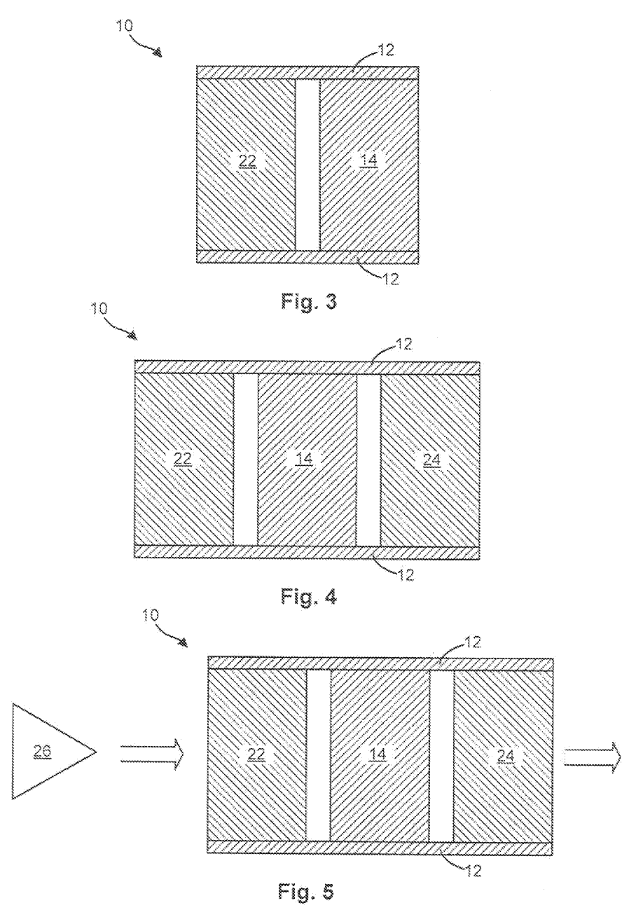

As is shown in FIG. 3, particulate filtering component 22 may also be associated with the sanitizing device 10. Particulate filtering component 22 is capable of substantially trapping particulates thereon, and may be fabricated from activated carbonaceous material(s). Particulate filtering component 22 is also capable of deodorizing an associated unclean medium (e.g. liquids including water, gasses including air, and mixtures of both). In accordance with the present invention, particulate filtering component 22 traps relatively larger components of an unclean medium, such as air borne dust, hair, dirt, etc. In this embodiment particulate filtering component 22 may be positioned in front or behind sanitizing component 14, although if the sanitizing component 14 is positioned behind particulate filter component 22, the incoming medium will contact the particulate filtering component first.

As is shown in FIG. 4, sanitizing device 10 may also include fragrance emitting means 24, such as a conventional electrochemical fragrance dispenser or a porous matrix material (as disclosed above) impregnated with a desired fragrant material. In this embodiment, the precise order of each component is not critical, however, if the particulate filtering component 22 is positioned before sanitizing component 14, and that fragrance emitting means is positioned last, the incoming medium will be filtered for particulates and disinfected prior to being associate with a fragrant material.

As is shown schematically in FIG. 5, sanitizing device 10 may also be associated with forced air means 26, such as a fan, a blower, etc. In this embodiment, unclean medium (in this case air) is directed to the device so that the sanitizing process can be expedited.

While specific multi-layer composite device configurations have been disclosed, for illustrative purposes only, it will be understood that numerous multi-layer composite configurations are contemplated for use including, but by no means limited to, the following: AB; BA; BC; CB; ABC; BCA; CBA; AAB; BBC; ABAC, ABBC, AABBCC; and ABCABC:
Wherein A=a particulate filtering component;
Wherein B=a sanitizing component; and
Wherein C=fragrance emitting means.

In operation, when a sanitizing component retained within a housing is only provided, unclean medium passes through sanitizing device 10, whereby the unclean medium having contaminants contacts sanitizing component 14. Upon contact with the sanitizing component, the contaminants contained within the unclean medium are beneficially altered or killed by “active materials” either impregnated into the porous matrix (in the case of a chemical purifier) or contained within an electrode or the electrolyte component (in the case of an electrochemical purifier).

Alternatively, if particulate filtering component 22 is also associated with sanitizing device 10, the unclean medium first passes through particulate filtering component 22, whereupon particulates are substantially trapped and do not continue into the sanitizing component. Adding such a component is desirous for conditions where relatively larger particulates may be found such as dirt, dust, hair, etc.

In addition, when fragrance emitting means 24 are associated with sanitizing device 10, the unclean medium is impregnated with a desirable fragrance just prior to exiting the filter. As such, although not necessary, the fragrance emitting means may be positioned as the last sanitizing device component.

It will be understood that sanitizing device 10 may be incorporated into any one of a number of sanitizing applications. For example, sanitizing device 10 may be configured for use in association with AC and/or DC powered portable air sanitizing devices. Alternatively, sanitizing device 10 may be configured to replace or supplement conventional filters in forced air heating/cooling systems including those in homes, commercial building, vehicles, airplanes, boats, etc. In such an application, sanitizing device 10 may be positioned in several places including, immediately prior or subsequent to any forced air means, immediately prior to a vent or register—just to name a few.

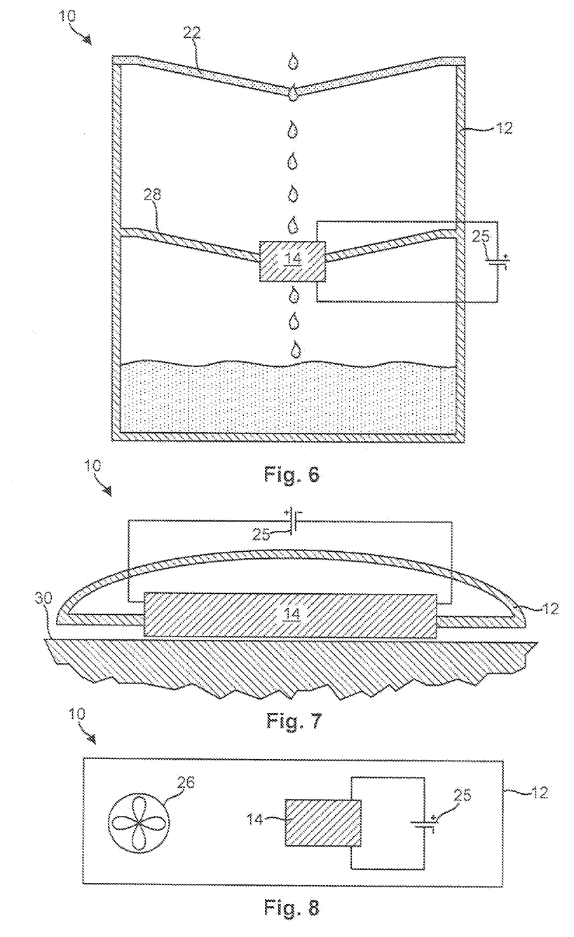

As is shown in FIG. 6, sanitizing device 10 may be operatively configured as a portable water purifier. In this embodiment sanitizing device 10 generally comprises housing 12, sanitizing component 14, filtering component 22, and reservoir member 28. For purposes of the present disclosure sanitizing component 14 may comprise an electrochemical and/or corona cell which is powered by AC current and/or DC current 25. The sanitizing component may include an electrochemical and/or corona cell that is generally porous so that water or other media can transport through such a cell.

In operation, a user pours a medium, such as water, on the top of filtering component 22, whereby particulates are isolated on top of the filtering component. Next the medium is gravity fed into reservoir member 28, whereupon the medium contacts sanitizing component 14. In accordance with above-identified embodiments, sanitizing member 14 purifies the medium upon contact. Once purified the medium is retained within the bottom of housing 12 for subsequent use.

As is shown in FIG. 7, sanitizing device 10 may be operatively configured as a surface disinfectant device. In this embodiment sanitizing device 10 generally comprises a housing 12 and sanitizing component 14. For purposes of the present disclosure sanitizing component 14 may comprise an electrochemical and/or corona cell which is powered by AC current and/or DC current 25. In operation, a user places sanitizing device 10 onto surface 30, whereupon application of an applied potential to sanitizing component 14, surface 30 is purified.

As is shown in FIG. 8, sanitizing device 10 may be operatively configured as a surrounding area sanitizing device. In this embodiment sanitizing device 10 generally comprises housing 12, sanitizing component 14, and forced air means 26. For purposes of the present disclosure sanitizing component 14 may comprise an electrochemical, chemical, and/or corona cell, which may be powered by AC current and/or DC current 25 if necessary. In operation, a user places sanitizing device 10 in a surrounding environment, such as a room. Once positioned, sanitizing component 14 and forced air means 26 are activated by application of an applied potential. Forced air means 26 inputs the surrounding environment within housing 12, whereby the surrounding environment contacts sanitizing component 14 which purifies the surrounding environment. Once purified, the surrounding environment is expelled out of housing 12 through a porous portion of sanitizing component or an aperture associated therewith.

It will be understood that the term “sanitize” is herein defined as the function of sanitizing, disinfecting, and/or otherwise beneficially effecting surfaces, liquids, gasses, and/or surrounding environments.

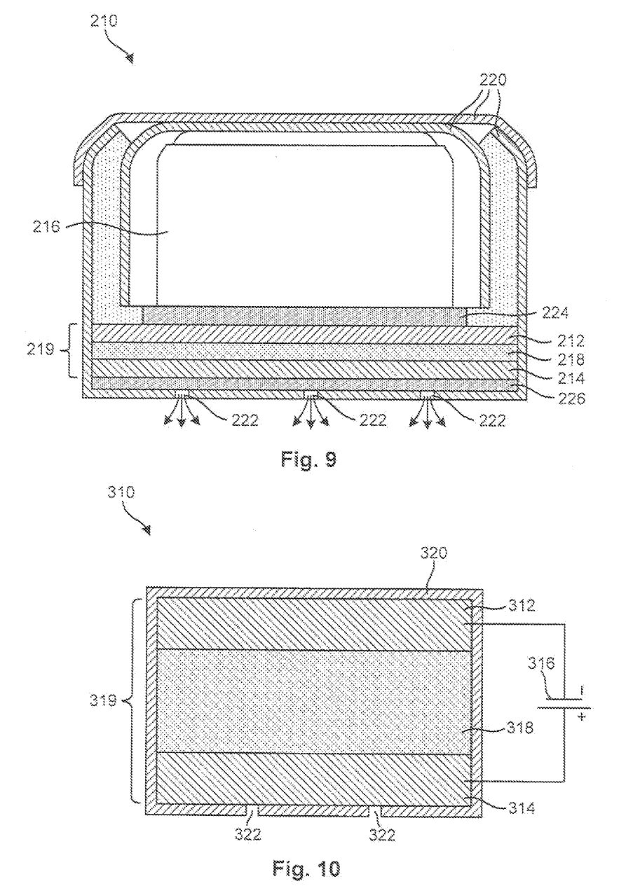

Referring to FIG. 9, one embodiment of a sanitizing device 210 in accordance with the invention may include a cathode 212 and an anode 214 in operable communication with an electrolyte component 218. Each of these components together forms an electrochemical cell 219, also known in the art as an electrolyte conductor 219. As will be appreciated by those of skill in the art, in embodiments where the electrolyte component 218, anode 214, and cathode 212 are in a solid state, electrolyte conductor 219 may be called a solid electrolyte conductor. A power source 216 may be connected to the anode 214 and cathode 212, respectively, to generate an electrical current therebetween. A power source 216 may include any device or system that provides an electromotive force between its terminals. In one embodiment, the power source 216 is a battery. In another embodiment, the power source 216 is an electrical outlet. In another embodiment, the power source 216 includes a solar cell. The power source 216 may include any number of devices to generate an electrical current.

The electrical current provided by the power source 216 oxidizes the anode 214 and reduces the cathode 212, thereby creating a chemical reaction at the anode 214 and cathode 212. In response to the electrical current flowing through the power source 216, an ionic current flows through the electrolyte 218, located between the anode 214 and cathode 212. In one embodiment, the ion conducting electrolyte component has an ionic conductivity greater than approximately 10⁻¹⁰ (ohm cm)⁻¹ at ambient temperatures. Optionally, the electrolyte conductor 219 may include a switch (not shown) to selectively interrupt the current between the anode 214 and cathode 212.

A housing 220 may be configured to contain or support at least the anode, the cathode, and the electrolyte. In one embodiment, the housing 220 includes an outlet 222 through which a sanitizer can exit the housing 220. The housing 220 may be configured to allow the positioning of electrolyte conductor 219 in close proximity to the surface to be sanitized. In this embodiment, there may be many outlets 222 to allow sanitizer to exit the housing onto the surface. In one embodiment, the outlet 222 may comprise an entire open end of the housing such that one of the electrodes 212 and 214 is in contact with, or adjacent to, the surface. The device 210 may be designed for use with an applicator (not shown) such as a sprayer, a brush, a wiper, a vaporizer, a mister, a spreader and the like. In these embodiments, the outlet 222 may be positioned for optimal application of the sanitizer to the particular surface, material, medium, or space to be sanitized. The outlet 222 may be configured for connection to one or more of any number of applicators.

In one embodiment, to generate a sanitizer, the anode 214 reacts upon oxidizing to generate the sanitizer or a component of the sanitizer and a cation. The cation flows through the electrolyte 218, which may be chosen to be a conductor of the particular cation released. The cation may then be reduced by a chemical reaction occurring at the cathode 214.

In one embodiment, one or more precursor materials (not shown) may be in operable communication with the anode 214, the cathode 212, or both to facilitate the generation or synthesis of the sanitizer. For example, as will be discussed in greater detail below, the sanitizer may be a compound containing a halogen or halide. In one embodiment, the sanitizer may include a chloride compound. A suitable precursor materials may be NaCl and/or an aqueous solution. Upon application of electric potential to the anode 214 and cathode 212 by the power source 216, the NaCl releases the cation Na³⁰ which passes through the cation selective membrane leaving the anion Cl⁻behind to react with water to form the chloride compound hypochlorous acid, a known sanitizer. The sanitizer release rate may be controlled by regulating the electrical current flowing through the electrolyte conductor 219.

In one embodiment, one or more reservoirs 224 and 226 may contain one or more precursor materials to facilitate the generation of sanitizer. The reservoirs 224 and 226 are in operable communication with one or more of the cathode 212 and anode 214 to facilitate reaction of the precursor material at the cathode 212 and/or anode 214. The reservoirs 224 and 226 may also be in operable communication with the electrolyte component 218 such that byproducts of the precursor material reaction at one or both of the anode 214 and cathode 212 may pass through the electrolyte component 218 and be available as a sanitizer or to participate in a further reaction to create a sanitizer.

For example, a first reservoir 224 in operable communication with the electrolyte component 218 may contain a first precursor material such as NaCl in an aqueous solution. A second reservoir 226 in operable communication with the electrolyte component 218 may contain a second precursor material such as water with a predetermined pH. In one embodiment, the water has a pH of less than about 9. The first reservoir may be in communication with the cathode 212 and the second reservoir 226 may be in communication with the anode 214. The electrolyte component 218 may be an anion selective membrane. With the application of potential to the anode 214 and cathode 212, the reaction at the cathode 212 is as follows:
2NaCl+2H₂O+2e⁻→2Cl⁻+2NaOH+H₂
This reaction uses electrons to free the anions Cl⁻which flow through the electrolyte 218, which in this example is an anion exchange or anion conducting membrane, to react with the precursor material in the reservoir associated with the anode 214. At the anode 14, the reactions may be described as follows:
2Cl⁻→Cl₂+2e⁻
Cl₂+H₂O→HOCl+HCl
It will be appreciated by those of skill in the art that the water in the second reservoir 226 may be a basic aqueous solution having a pH less than about 9 in order to minimize the HCl produced and maximize the HOCl produced. In one embodiment, the pH level of the aqueous solution is controlled by adding or subtracting amounts of H₂O₂ to the second reservoir 226.

In an alternative embodiment, the electrolyte component 218 may be a cation exchange or cation conducting membrane. In this embodiment, the NaCl solution may be in a reservoir associated with the anode 214 and the water with a predetermined pH may be in the reservoir associated with the cathode 212. In this configuration, the reaction at the anode may be described as follows:
2NaCl+2H₂O→2Na⁺+2HCl+H₂+2e⁻
2Cl⁻→Cl₂+2e⁻
Cl₂+H₂O→HOCl+HCl
This reaction frees two electrons to produces the cations Na³⁰ that flow through the cation conducting electrolyte component 218 to react with the precursor material in the reservoir associated with the Cathode 212. The remaining chloride ions react with water to form the sanitizer, hypochlorous acid. At the cathode 214, the reactions may be described as follows:
2Na⁺+2e⁻→Na₂
Na₂ +H₂O→2NaOH+ 1/2H₂
It will be appreciated by those of skill in the art that to minimize the HCl produced at the anode 214 after the sodium ions pass through the electrolyte component 218, the pH of the initial NaCl solution in the cathode 214 reservoir may contain an aqueous solution having a pH greater than about 3. In another embodiment, the pH is greater that about 7. In one embodiment, the pH level of the aqueous solution is controlled by adding or subtracting amounts of H₂O₂ to the reservoir where HCl could be formed to reduce its formation.

The reservoirs 224 and 226 could be any device or structure to hold precursor material. For example, in embodiments where the device 210 is used to sanitize a surface such as skin, the device may be in the form of a patch and the reservoirs 224, 226 may be an absorbent pad such as gauze. The reservoir may include a fibrous matrix or other aqueous retaining structures. In other embodiments, the reservoirs may be traditional analyte and catholyte chambers of a type known in the art.

It will be appreciated by those of skill in the art that the configuration of the anode 214, cathode 212, electrolyte component 218, and reservoirs 224 and 226 in relation to each other can vary and still accomplish the teachings of the invention. The relationship and placement of these elements 212, 214, 218, 224, and 226 to each other and the configuration of each individual element 212, 214, 218, 224, and 226 may depend upon the sanitizer to be produced and the application of the sanitizer. The placement of the elements 212, 214, 218, 224 and 226 will depend on the chemistry used to create the sanitizer and how to make the creation more efficient. For example, it may desirous to have reservoir 224 and 226 between a respective anode 214 or cathode 212 and the electrolyte component 218. In another embodiment, it may be desirous to have the anode 214 and cathode 212 adjacent the electrolyte component 218. In this embodiment, as will be appreciated by those of skill in the art, the electrodes 212 and 214 may need to be porous to allow precursor material or precursor material byproduct access to the electrolyte component 218.

In certain embodiments, the electrolyte component 218 comprises a solid polymer. In one embodiment, the solid polymer may be a cation conducting polymer membrane, an anion conducting polymer membrane, a sulfonated tetrafluorethylene membrane of the type sold under the Nafion® brand, combinations thereof, and the like. The electrolyte component 218 could also be a solid inorganic material such as NaSICON or beta alumina. In one embodiment, the electrolyte component 218 is one or more of NaSICON substituted with Ag ions, NaSICON substituted with Cu ions, NaSICON substituted with Li ions, NaSICON substituted with Rb ions, NaSICON substituted with Na ions, NaSICON substituted with H ions, NaSICON substituted with Mg ions, and the like. In another embodiment, the electrolyte component 218 is one or more of beta alumina substituted with Ag ions, beta alumina substituted with Cu ions, beta alumina substituted with Li ions, beta alumina substituted with Rb ions, beta alumina substituted with Na ions, beta alumina substituted with H ions, beta alumina substituted with Mg ions, and combinations thereof. In one embodiment, the electrolyte component is an ion exchange membrane sold under the NEOSEPTA® brand by the Tokuyama Corporation. In other embodiments, the electrolyte component 218 may include anion or cation conducting or selective membranes. The electrolyte component 218 may also be those discussed in associated with FIGS. 1-8 above.

The anode 214 and cathode 212 may be fabricated from the same or different materials, including metals, conductive ceramics (including a particulate filtering component), and mixtures thereof. In one embodiment, anode 214 or cathode 212 metals include metals such as titanium, nickel, copper, silver, platinum, palladium, zinc, as well as aluminum, steel, and mixtures and alloys thereof. The anode 214 and cathode 212 may also include carbon. Conductive ceramics may include perovskites, carbides, nitrides of metals, and mixtures thereof. The anode 214 and cathode 212 may be substantially porous or dense, depending upon the desired sanitizer. In one embodiment, a porous 212 cathode or porous anode 214 may be infiltrated with the electrolyte component 218.

In one embodiment, the anode 214 and cathode 212 comprise an element having an atomic weight of less than about 50. In other embodiments, the anode 214 and cathode 212 do not contain any element with an atomic weight greater than 50. It will be appreciated by those of skill in the art that lighter metals such as titanium are useful in many application to make the overall device 210 lighter. While certain anode 214 and cathode 212 materials have been disclosed, for illustrative purposes only, it will be understood that numerous other conventional anode and cathode materials are likewise contemplated for use.

In operation, a user decides what to sanitize and selects a desired sanitizer. The user may then select an appropriate precursor for an electrochemical cell, (electrolyte conductor) 219 to use in the formation of the sanitizer. The user may then decide how to incorporate the precursor into the electrolyte conductor 219, for example as part of the cathode 212, anode 214, electrolyte component 218, or one or more reservoirs 224, 226. The user may then decide upon placement of the device 210 in relation to the medium or material to be sanitized in order to cause the most efficient sanitizing effect. For example, it the user is sanitizing a surface, the user may place the device 210 on the surface in order to release sanitizer directly to the surface. If the user is sanitizing a space, the user may attach an applicator such as a sprayer or spreader to apply the sanitizer to the space. The user may also place the device 210 within the space in order to put the sanitizer in contact with the medium or material to be sanitized. If the user is sanitizing a liquid, the user may utilize an embodiment of the device 210 that can be totally or partially submerged in the liquid. The user may also utilize an embodiment of the device 210 configured to receive the liquid within the housing 220 or other receptacle (not shown). The user may also decide to utilize an embodiment of the device 210 configured with an outlet 222 to receive a hose which can be place within or adjacent the liquid to apply sanitizer to the liquid.

Referring now to FIG. 10, another embodiment of a sanitizing device 310 according to the present invention is shown. This embodiment 310 may also include a solid electrolyte conductor 319 having a cathode 312, an anode 314, and an electrolyte component 318. A power source 316 may be connected to the anode 311 and cathode 312, respectively, to generate an electrical current therebetween. A power source 316 may include any device or system that provides an electromotive force between its terminals. The electrical current oxidizes the anode 314 and reduces the cathode 311, thereby creating a chemical reaction at the anode 314 and cathode 312. In response to the electrical current flowing through the power source 316, an ionic current flows through the electrolyte 318, located between the anode 314 and cathode 312. Optionally, the electrolyte conductor 319 may include a switch (not shown) to selectively interrupt the current between the anode 314 and cathode 312. The device 310 may include a housing 320 operably connected to the anode 314, cathode 312, and electrolyte component 318.

In this embodiment, the sanitizer may be a silver compound, an iodine compound, or other sanitizing agent. As stated above, the sanitizer may be created from a precursor material. In one embodiment, the precursor material comprises one of the group consisting of silver halides, silver chalcogenides, silver phosphates, silver tungstates, silver zirconates, silver aluminates, silver titanates, and combinations thereof. The precursor material may be built into the components of the device 310. For example, the cathode 312, anode 314, and/or electrolyte 318 may include or be formulated from the precursor material. In one embodiment, the precursor material is infiltrated into the component 312, 314, or 318.

In one embodiment, the electrolyte component 318 may include a porous matrix substantially impregnated with a precursor material selected from the group consisting essentially of peroxides, superoxides, fluorates, chlorates, bromates, iodates, permanganates, and mixtures thereof. In another embodiment, the electrolyte component 318 may be oxide containing materials and may include composites of metal oxides and ion conducting materials (e.g. AgI-Al₂O₃ composites) as well as beta-aluminas's (Mₓ O-11Al₂O₃) or Nasicon materials.

In the embodiment, where the electrolyte component 318 is AgI-Al₂O₃, the precursor material is AgI. Upon application of potential to the anode 314 and cathode 312 the following reactions may occur at the cathode 312:
Ag++e⁻→Ag
where Ag accumulates at the cathode 312. At the anode 314, the following reaction occurs:
I⁻→e⁻+ 1/2I₂
where I₂ accumulates at the anode 314. Both iodine and silver are sanitizers and it will be appreciated by those of skill in the art that the electrodes 312 and 314 could be arranged to provide either sanitizer to the outlet 322 in the housing 320.

In other embodiments, the anode 314, cathode 312, and electrolyte component may be fabricated from the materials discussed above. The electrolyte component 318 may be coated with anode 314 or cathode 312 material. In other embodiments, the anode 314 and/or cathode 312 is infiltrated with electrolyte component material 318. In use, the device 310 may be utilized as described above.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. A sanitizing device comprising:
a ion conducting electrolyte component having ionic conductivity greater than approximately 10⁻¹⁰ (ohm cm)⁻¹ at ambient temperatures;
an anode in operable communication with the electrolyte component;
a cathode in operable communication with the electrolyte component;
at least one precursor material in operable communication with one or more of the anode and cathode;
a power source operably connected to the anode and cathode, such that upon application of electric potential to the anode and cathode by the power source, a sanitizer will be formed from the precursor; and
a housing for containing at least the anode, the cathode, and the electrolyte component, the housing having an outlet through which the sanitizer can exit the housing.

2. The device of claim 1, wherein the electrolyte component comprises a solid polymer.

3. The device of claim 2, wherein the solid polymer comprises one of the group consisting of a cation conducting polymer membrane, an anion conducting polymer membrane, a sulfonated tetrafluorethylene membrane, and combinations thereof.

4. The device of claim 1, wherein the electrolyte component comprises a solid inorganic material.

5. The device of claim 4, wherein the solid inorganic material comprises NaSICON, beta alumina, NaSICON substituted with Ag ions, NaSICON substituted with Cu ions, NaSICON substituted with Li ions, NaSICON substituted with Rb ions, NaSICON substituted with Na ions, NaSICON substituted with H ions, NaSICON substituted with Mg ions, beta alumina substituted with Ag ions, beta alumina substituted with Cu ions, beta alumina substituted with Li ions, beta alumina substituted with Rb ions, beta alumina substituted with Na ions, beta alumina substituted with H ions, beta alumina substituted with Mg ions, and combinations thereof.

6. The device of claim 1, wherein the electrolyte comprises the precursor material.

7. The device of claim 6, wherein the precursor material comprises one of the group consisting of silver halides, silver chalcogenides, silver phosphates, silver tungstates, silver zirconates, silver aluminates, silver titanates, and combinations thereof.

8. The device of claim 1, wherein the anode comprises the precursor material.

9. The device of claim 8, wherein the precursor material comprises one of the group consisting of silver halides, silver chalcogenides, silver phosphates, silver tungstates, silver zirconates, silver aluminates, silver titanates, and combinations thereof.

10. The device of claim 1, wherein the cathode comprises the precursor material.

11. The device of claim 10, wherein the precursor material comprises one of the group consisting of silver halides, silver chalcogenides, silver phosphates, silver tungstates, silver zirconates, silver aluminates, silver titanates, and combinations thereof.

12. The device of claim 1, further comprising a reservoir in communication with one or more of the cathode and anode, said reservoir comprising the precursor material.

13. The device of claim 12, wherein the precursor material comprises a halide or halogen compound.

14. The device of claim 13, wherein the precursor material comprises NaCl.

15. The device of claim 12, wherein the precursor material is an aqueous solution.

16. The device of claim 15, wherein the aqueous solution has a pH of less than about 9.

17. The device of claim 15, wherein the aqueous solution has a pH of greater than about 3.

18. The device of claim 1, wherein the electrolyte component, anode, and cathode are all in a solid state.

19. The device of claim 1, wherein the sanitizer comprises a silver compound.

20. The device of claim 1, wherein the sanitizer comprises an iodine compound.

21. The device of claim 1, wherein the sanitizer comprises a halide or halogen compound.

22. The device of claim 21, wherein the sanitizer comprises hypochlorous acid.

23. The device of claim 1, wherein in the anode comprises an element having an atomic weight of less than about 50.

24. The device of claim 23, wherein the anode comprises one of the group consisting of titanium, carbon, and combinations thereof.

25. The device of claim 23, wherein the anode is substantially porous and is infiltrated with the electrolyte component.

26. The device of claim 1, wherein the cathode comprises an element having an atomic weight of less than about 50.

27. The device of claim 26, wherein the cathode comprises one of the group consisting of titanium, carbon, and combinations thereof.

28. The device of claim 26, wherein the cathode is substantially porous and is infiltrated with electrolyte component.

29. The device of claim 1, wherein the anode does not include an element having an atomic weight of greater than about 50.

30. The device of claim 1, wherein the cathode does not include an element having an atomic weight of greater than about 50.

31. A sanitizing device comprising:
a solid state ion conducting electrolyte component having ionic conductivity greater than approximately 10⁻¹⁰ (ohm cm)⁻¹ at ambient temperatures, the electrolyte component comprising a precursor material;
a solid state anode in operable communication with the electrolyte component;
a solid state cathode in operable communication with the electrolyte component;
a power source operably connected to the anode and cathode, such that upon application of electric potential to the anode and cathode by the power source, a sanitizer will be formed from the precursor; and
a housing for containing at least the anode, the cathode, and the electrolyte component, the housing having an outlet through which the sanitizer can exit the housing.

32. The device of claim 31, wherein the electrolyte component comprises a solid polymer.

33. The device of claim 32, wherein the solid polymer comprises one of the group consisting of a cation conducting polymer membrane, an anion conducting polymer membrane, a sulfonated tetrafluorethylene membrane, and combinations thereof.

34. The device of claim 31, wherein the electrolyte component comprises a solid inorganic material.

35. The device of claim 34, wherein the solid inorganic material comprises NaSICON, beta alumina, NaSICON substituted with Ag ions, NaSICON substituted with Cu ions, NaSICON substituted with Li ions, NaSICON substituted with Rb ions, NaSICON substituted with Na ions, NaSICON substituted with H ions, NaSICON substituted with Mg ions, beta alumina substituted with Ag ions, beta alumina substituted with Cu ions, beta alumina substituted with Li ions, beta alumina substituted with Rb ions, beta alumina substituted with Na ions, beta alumina substituted with H ions, beta alumina substituted with Mg ions, and combinations thereof.

36. The device of claim 31, wherein the precursor material comprises one of the group consisting of silver halides, silver chalcogenides, silver phosphates, silver tungstates, silver zirconates, silver aluminates, silver titanates, and combinations thereof.

37. The device of claim 36, wherein the sanitizer comprises a silver compound.

38. The device of claim 31, wherein in the anode comprises an element having an atomic weight of less than about 50.

39. The device of claim 31, wherein the cathode comprises an element having an atomic weight of less than about 50.

40. A sanitizing device comprising:
a ion conducting electrolyte component having ionic conductivity greater than approximately 10⁻¹⁰ (ohm cm)⁻¹ at ambient temperatures;
an anode in operable communication with the electrolyte component;
a cathode in operable communication with the electrolyte component;
a first reservoir in operable communication with the electrolyte component, the first reservoir comprising a first precursor material;
a power source operably connected to the anode and cathode, such that upon application of electric potential to the anode and cathode by the power source, a sanitizer will be formed from the precursor; and
a housing for containing at least the anode, the cathode, and the electrolyte component, the housing having an outlet through which the sanitizer can exit the housing.

41. The device of claim 40, wherein the electrolyte component comprises a solid polymer.

42. The device of claim 41, wherein the solid polymer comprises one of the group consisting of a cation conducting polymer membrane, an anion conducting polymer membrane, a sulfonated tetrafluorethylene membrane, and combinations thereof.

43. The device of claim 40, wherein the electrolyte component comprises a solid inorganic material.

44. The device of claim 43, wherein the solid inorganic material comprises NaSICON, beta alumina, NaSICON substituted with Ag ions, NaSICON substituted with Cu ions, NaSICON substituted with Li ions, NaSICON substituted with Rb ions, NaSICON substituted with Na ions, NaSICON substituted with H ions, NaSICON substituted with Mg ions, beta alumina substituted with Ag ions, beta alumina substituted with Cu ions, beta alumina substituted with Li ions, beta alumina substituted with Rb ions, beta alumina substituted with Na ions, beta alumina substituted with H ions, beta alumina substituted with Mg ions, and combinations thereof.

45. The device of claim 41, wherein the first precursor material comprises a halogen or halide compound.

46. The device of claim 45, wherein the first precursor material comprises NaCl.

47. The device of claim 40, further comprising a second reservoir comprising a second precursor.

48. The device of claim 47, wherein the second precursor material is an aqueous solution.

49. The device of claim 48, wherein the aqueous solution has a pH of less than about 9.

50. The device of claim 49, wherein the aqueous solution has a pH of greater than about 3.

51. The device of claim 40, wherein the sanitizer comprises a halogen or halide compound.

52. The device of claim 51, wherein the sanitizer comprises hypochlorous acid.

53. The device of claim 40, wherein in the anode comprises an element having an atomic weight of less than about 50.

54. The device of claim 40, wherein the cathode comprises an element having an atomic weight of less than about 50.

55. A sanitizing device comprising:
a ion conducting electrolyte component having ionic conductivity greater than approximately 10⁻¹⁰ (ohm cm)⁻¹ at ambient temperatures, the electrolyte component comprising NaSICON;
a porous titanium anode in operable communication with the electrolyte component;
a porous titanium cathode in operable communication with the electrolyte component;
a first reservoir in operable communication with the electrolyte component, the first reservoir comprising a chloride compound;
a second reservoir in operable communication with the electrolyte component, the second reservoir comprising an aqueous solution having a pH of between about 3 and about 9;
a power source operably connected to the anode and cathode, such that upon application of electric potential to the anode and cathode by the power source, hypochlorous acid will be formed from the first and second precursors; and
a housing for containing at least the anode, the cathode, and the electrolyte component, the housing having an outlet through which the hypochlorous acid can exit the housing.

56. A sanitizing device comprising:
a solid NaSICON electrolyte component;
an anode in operable communication with the electrolyte component;
a cathode in operable communication with the electrolyte component;
at least one precursor material in operable communication with one or more of the anode and cathode;
a power source operably connected to the anode and cathode, such that upon application of electric potential to the anode and cathode by the power source, a sanitizer will be formed from the precursor; and
a housing operably connected to the anode, the cathode, and the electrolyte component, the housing having an outlet through which the sanitizer can exit the housing.
